(19) United States
(12) Patent Application Publication
(10) Pub. No.: US 2012/0271612 A1
(43) Pub. Date: Oct. 25, 2012

(54) PREDICTIVE MODELING

(76) Inventors: Wael K. Barsoum, Bay Village, OH (US); Michael W. Kattan, Cleveland, OH (US); William H. Morris, Shaker Heights, OH (US); Douglas R. Johnston, Shaker Heights, OH (US)

(21) Appl. No.: 13/451,984

(22) Filed: Apr. 20, 2012

Related U.S. Application Data
(60) Provisional application No. 61/477,381, filed on Apr. 20, 2011.

(51) Int. Cl. G06G 7/60

(52) U.S. Cl. 703/11

(57) ABSTRACT

This disclosure relates to predictive modeling. Systems and methods can be utilized extract data from a plurality of data sources to provide a set of predictor variables. The predictor variables can be analyzed to generate a model having a portion of the predictor variables with weighted coefficients according to an event or outcome for which the model is generated. A prediction tool can employ the model to predict the even or outcome for one or more patients.

### CROSS-REFERENCE TO RELATED APPLICATION

This application claims the benefit of U.S. Provisional Patent Application No. 61/477,381, filed Apr. 20, 2011 and entitled PREDICTIVE MODELING, which is incorporated herein by reference in its entirety.

### REFERENCE TO APPENDICES

This disclosure includes Appendices A, B and C, which form an integral part of this application and are incorporated herein, in which:

Appendix A demonstrates an example data set that can be utilized for generating a model.

Appendix B depicts an example of another data set that can be utilized as part of the generating a model.

Appendix C depicts examples of coefficients and predictors that can be generated as part of the model generation process.

### TECHNICAL FIELD

This disclosure relates to systems and methods to generate a predictive model, such as can be utilized to predict a patient condition or event.

### BACKGROUND

There are increasing efforts to predict patient outcomes and to provide decision support for helping physicians make decisions with individual patients. For example, predictive analysis in health care has been to determine which patients are at risk of developing certain conditions, like diabetes, asthma, heart disease and other lifetime illnesses. Additionally, some clinical decision support systems may incorporate predictive analytics to support medical decision making at the point of care.

### SUMMARY

This disclosure relates to systems and methods to generate a predictive model, such as can be utilized to predict a patient condition or event.

As one example, a computer implemented method can include extracting patient data from a database, the patient data comprising final coded data for each of a plurality of patients and encounter patient data for at least a subset of the plurality of patients. For example, the final coded data set can include ICD codes, procedure codes as well as demographic information for each patient. A value (e.g., a dummy code) can be assigned to each code in a set of possible codes for each respective patient based on comparing data for each patient in the final coded data relative to the set of possible codes to provide model data. A value can also be assigned to each code of the set of possible codes for each respective patient in the subset of patients based on comparing data for each patient in the encounter patient data relative to the set of possible codes to provide testing data. A model can be generated for predicting a selected patient event or outcome, the model having a plurality of predictor variables, corresponding to a selected set of the possible codes, derived from the model data, each of the predictor variables having coefficients calculated from the testing data based on analytical processing including a concordance index of the variable to the patient event or outcome.

One or more such model can be stored in memory. For example, the model can be utilized by a prediction tool to compute a prediction for an event or outcome for a given patient in response to input encounter data for the given patient. The method can also be stored in a non-transitory medium as machine readable instructions that can be executed by a processor, such as in response to a user input.

### BRIEF DESCRIPTION OF THE DRAWINGS

FIG. 1 depicts an example of a system for generating a model to predict a patient outcome.

FIG. 2 depicts an example of a model generator.

FIG. 3 depicts an example of how a model can be modified for predicting a patient outcome.

FIG. 4 is a flow diagram depicting an example method for generating a predictive model.

FIG. 5 is a flow diagram depicting an example method for using a predictive model to predict an event or outcome.

### DETAILED DESCRIPTION

This disclosure relates to systems and methods for generating a model and using the model for predicting patient outcomes based on such models.

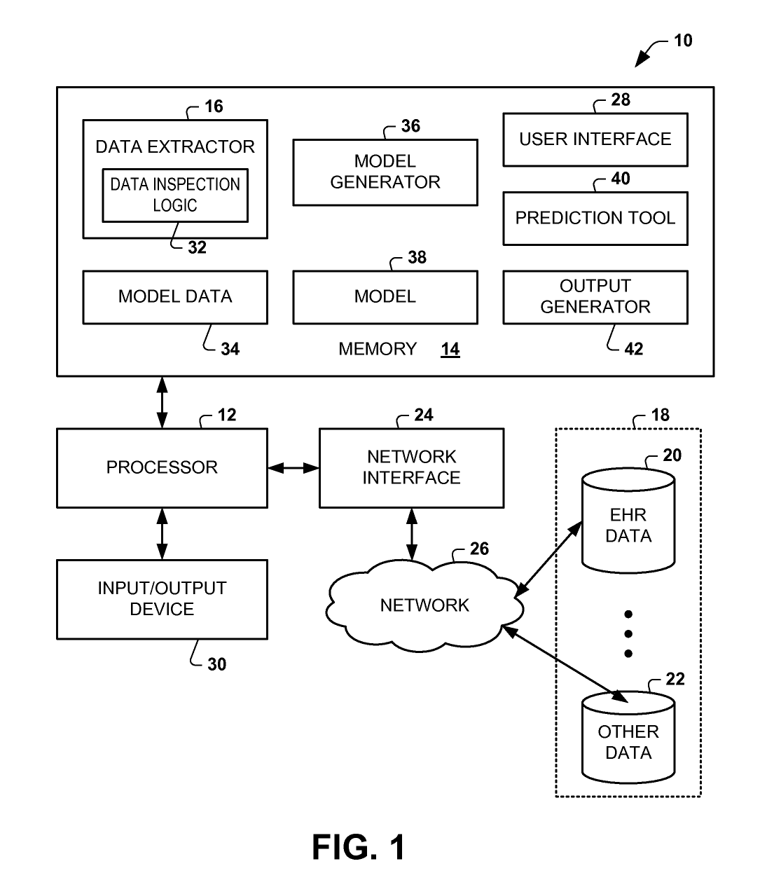

FIG. 1 depicts an example of a system 10 for generating a model to predict patient outcomes. The predicted patient outcomes can include, for example, patient length of stay, patient satisfaction, a patient diagnosis, patient prognosis, patient resource utilization or any other patient outcome information that may be relevant to a healthcare provider, patient or healthcare facility. The system 10 can be programmed to generate a model for one or more patient outcomes based on patient data for a plurality of predictor variables. The system 10 can employ the model to input data for a given patient to provide the predicted outcome or outcomes for the given patient or groups of patients.

The system 10 includes a processor 12 and memory 14, such as can be implemented in a server or other computer. The memory 14 can store computer readable instructions and data. The processor 12 can access the memory 14 for executing computer readable instructions, such as for performing the functions and methods described herein.

In the example of FIG. 1, the memory 14 includes computer readable instructions comprising a data extractor 16. The data extractor 16 is programmed to extract patient data from one or more source of data 18. The sources of data 18 can include for example, electronic health record (EHR) database 20 as well one or more other sources of data, indicated at 22. The other sources of data 22 can include any type of patient data that may contain information associated with a patient, a patient's stay, a patient's health condition, a patient's opinion of a healthcare facility and/or its personnel, and the like.

The patient data in the sources of data 18 can represent information for a plurality of different categories in a coded data set. By way of example, the categories of patient data utilized in generating a predictive model can include the following: patient demographic data; all patient refined (APR) severity information, APR diagnosis related group (DRG) information, problem list codes, final billing codes, final procedure codes, prescribed medications, lab results and patient satisfaction. Thus, the data extractor 16 can extract data relevant to any one or more of the categories of patient data from the respective databases 20 and 22 in the sources of data 18.

For the categories mentioned above, the following Table provides an example data structure that includes fields and their respective attributes that can be utilized for storing data acquired by the data extractor 16, such as for use in generating a model as disclosed herein. The following Table and elsewhere disclosed herein mentions codes that are utilized for generating the model, which codes correspond to the International Statistical Classification of Diseases and Related Health Problems (ICD), such as ICD-9 or ICD-10 codes. Other versions of ICD codes as well as different coding schemes, including publically available and proprietary codes, can also be utilized in the systems and methods disclosed herein.

TABLE

| Field Name | Field Attribute |
|---|---|
| PATIENT_ID | VARCHAR2 (18 Byte) |
| PATIENT_MRN_ID | VARCHAR2 (25 Byte) |
| PAT_ENCOUNTER_ID | NUMBER (18) |
| GENDER | VARCHAR2 (1 Byte) |
| LENGTH_OF_STAY (LOS) | NUMBER |
| PATIENT_AGE | NUMBER |
| HOSP_ADMSN_TIME | DATE |
| HOSP_DISCHRG_TIME | DATE |
| ADMIT_UNIT | VARCHAR2 (10 Byte) |
| TSI_APR_SEVERITY | NUMBER |
| TSI_APR_DRG | VARCHAR2 (10 Byte) |
| TARGET_LOS | NUMBER |
| ICD9_PBL_0 | VARCHAR2 (4000 Byte) |
| ICD9_PBL_0_5 | VARCHAR2 (4000 Byte) |
| ICD9_PBL_1 | VARCHAR2 (4000 Byte) |
| ICD9_PBL_1_5 | VARCHAR2 (4000 Byte) |
| ICD9_PBL_2 | VARCHAR2 (4000 Byte) |
| ICD9_PBL_2_5 | VARCHAR2 (4000 Byte) |
| ICD9_PBL_3 | VARCHAR2 (4000 Byte) |
| ICD9_PBL_3_5 | VARCHAR2 (4000 Byte) |
| ICD9_PBL_4 | VARCHAR2 (4000 Byte) |
| ICD9_PBL_4_5 | VARCHAR2 (4000 Byte) |
| ICD9_PBL_5 | VARCHAR2 (4000 Byte) |
| ICD9_PBL_5_5 | VARCHAR2 (4000 Byte) |
| ICD9_PBL_6 | VARCHAR2 (4000 Byte) |
| ICD9_PBL_6_5 | VARCHAR2 (4000 Byte) |
| ICD9_PBL_7 | VARCHAR2 (4000 Byte) |
| ICD9_PBL_7_5 | VARCHAR2 (4000 Byte) |
| ICD9_PBL_8 | VARCHAR2 (4000 Byte) |
| ICD9_PBL_8_5 | VARCHAR2 (4000 Byte) |
| ICD9_PBL_9 | VARCHAR2 (4000 Byte) |
| ICD9_PBL_9_5 | VARCHAR2 (4000 Byte) |
| ICD9_PBL_OTH | VARCHAR2 (4000 Byte) |
| ICD9_PBL_V | VARCHAR2 (4000 Byte) |
| ICD9_TSI_0 | VARCHAR2 (4000 Byte) |
| ICD9_TSI_0_5 | VARCHAR2 (4000 Byte) |
| ICD9_TSI_1 | VARCHAR2 (4000 Byte) |
| ICD9_TSI_1_5 | VARCHAR2 (4000 Byte) |
| ICD9_TSI_2 | VARCHAR2 (4000 Byte) |
| ICD9_TSI_2_5 | VARCHAR2 (4000 Byte) |
| ICD9_TSI_3 | VARCHAR2 (4000 Byte) |
| ICD9_TSI_3_5 | VARCHAR2 (4000 Byte) |
| ICD9_TSI_4 | VARCHAR2 (4000 Byte) |
| ICD9_TSI_4_5 | VARCHAR2 (4000 Byte) |
| ICD9_TSI_5 | VARCHAR2 (4000 Byte) |
| ICD9_TSI_5_5 | VARCHAR2 (4000 Byte) |
| ICD9_TSI_6 | VARCHAR2 (4000 Byte) |
| ICD9_TSI_6_5 | VARCHAR2 (4000 Byte) |
| ICD9_TSI_7 | VARCHAR2 (4000 Byte) |
| ICD9_TSI_7_5 | VARCHAR2 (4000 Byte) |
| ICD9_TSI_8 | VARCHAR2 (4000 Byte) |
| ICD9_TSI_8_5 | VARCHAR2 (4000 Byte) |
| ICD9_TSI_9 | VARCHAR2 (4000 Byte) |
| ICD9_TSI_9_5 | VARCHAR2 (4000 Byte) |
| ICD9_TSI_OTH | VARCHAR2 (4000 Byte) |
| ICD9_TSI_V | VARCHAR2 (4000 Byte) |
| PROC_TSI_0 | VARCHAR2 (4000 Byte) |
| PROC_TSI_0_5 | VARCHAR2 (4000 Byte) |
| PROC_TSI_1 | VARCHAR2 (4000 Byte) |
| PROC_TSI_1_5 | VARCHAR2 (4000 Byte) |
| PROC_TSI_2 | VARCHAR2 (4000 Byte) |
| PROC_TSI_2_5 | VARCHAR2 (4000 Byte) |
| PROC_TSI_3 | VARCHAR2 (4000 Byte) |
| PROC_TSI_3_5 | VARCHAR2 (4000 Byte) |
| PROC_TSI_4 | VARCHAR2 (4000 Byte) |
| PROC_TSI_4_5 | VARCHAR2 (4000 Byte) |
| PROC_TSI_5 | VARCHAR2 (4000 Byte) |
| PROC_TSI_5_5 | VARCHAR2 (4000 Byte) |
| PROC_TSI_6 | VARCHAR2 (4000 Byte) |
| PROC_TSI_6_5 | VARCHAR2 (4000 Byte) |
| PROC_TSI_7 | VARCHAR2 (4000 Byte) |
| PROC_TSI_7_5 | VARCHAR2 (4000 Byte) |
| PROC_TSI_8 | VARCHAR2 (4000 Byte) |
| PROC_TSI_8_5 | VARCHAR2 (4000 Byte) |
| PROC_TSI_9 | VARCHAR2 (4000 Byte) |
| PROC_TSI_9_5 | VARCHAR2 (4000 Byte) |
| MED_A | VARCHAR2 (4000 Byte) |
| MED_B | VARCHAR2 (4000 Byte) |
| MED_C | VARCHAR2 (4000 Byte) |
| MED_D | VARCHAR2 (4000 Byte) |
| MED_E | VARCHAR2 (4000 Byte) |
| MED_F | VARCHAR2 (4000 Byte) |
| MED_G | VARCHAR2 (4000 Byte) |
| MED_H | VARCHAR2 (4000 Byte) |
| MED_I | VARCHAR2 (4000 Byte) |
| MED_J | VARCHAR2 (4000 Byte) |
| MED_K | VARCHAR2 (4000 Byte) |
| MED_L | VARCHAR2 (4000 Byte) |
| MED_M | VARCHAR2 (4000 Byte) |
| MED_N | VARCHAR2 (4000 Byte) |
| MED_O | VARCHAR2 (4000 Byte) |
| MED_P | VARCHAR2 (4000 Byte) |
| MED_Q | VARCHAR2 (4000 Byte) |
| MED_R | VARCHAR2 (4000 Byte) |
| MED_S | VARCHAR2 (4000 Byte) |
| MED_T | VARCHAR2 (4000 Byte) |
| MED_U | VARCHAR2 (4000 Byte) |
| MED_V | VARCHAR2 (4000 Byte) |
| MED_W | VARCHAR2 (4000 Byte) |
| MED_X | VARCHAR2 (4000 Byte) |
| MED_Y | VARCHAR2 (4000 Byte) |
| MED_Z | VARCHAR2 (4000 Byte) |
| MED_0_9 | VARCHAR2 (4000 Byte) |
| LAB_BUN | NUMBER |
| LAB_K | NUMBER |
| LAB_NA | NUMBER |
| LAB_HCO3 | NUMBER |
| LAB_CREATININE | NUMBER |
| LAB_WBC | NUMBER |
| LAB_HGB | NUMBER |
| LAB_PLT | NUMBER |
| LAB_AST | NUMBER |
| LAB_ALT | NUMBER |
| LAB_CK | NUMBER |
| LAB_TROPONIN_T | NUMBER |
| LAB_TROPONIN_I | NUMBER |
| LAB_CK_NP | NUMBER |
| LAB_BNP | NUMBER |
| LAB_PT | NUMBER |
| LAB_PTT | NUMBER |
| LAB_INR | NUMBER |
| LAB_TL_BILI | NUMBER |
| LAB_ALP | NUMBER |

In the example of FIG. 1, the processor 12 can employ a network interface 24 that is coupled to a network 26 to access and retrieve the data from the source of data 18. There can be any number of one or more data sources 18. The network 26 can include a local area network (LAN), a wide area network (WAN), such as the internet or an enterprise intranet, and may include physical communication media (e.g., optical fiber or electrically conductive wire), wireless media or a combination of physical and wireless communication media.

A user interface 28 can be utilized to configure the data extractor 16 for setting extraction parameters, such as to identify the source of the data 18 as well as select the types and content of data to be extracted from each respective source of data 20 and 22. For example, a user can employ and input/output device 30 to access the functions and methods provided by the user interface 28 for setting the appropriate parameters associated with the data extraction process. The input/output device 30 can include a keyboard, a mouse, a touch screen or other device and/or software that provides a human machine interface with the system 10.

In one example, the data extractor 16 is programmed to extract patient data that includes a final coded data set for each of a plurality of patients as well as a patient encounter data set for at least a subset of the plurality of patients over a time period, such as can be specified as a range of dates and times. Such patient data can be stored in the memory 14 as model data 34. Thus, the model data 34 can comprise a set of training data corresponding to the set final coded data and another set of testing data that corresponds to the patient encounter data. As disclosed herein, these two sets can be utilized to generate one or more models for predicting a selected patient event or outcome. For a selected event or outcome, each of the patients is known to have the selected event or outcome for which the model is being generated. Thus, the extractor 16 can limit acquire the data from the data sources to the group of patients known to have the selected event or outcome, which can be identified in the final coded data for each patient. Patient's not known to have the selected event or outcome can be excluded by the extractor 16 as to not be used to provide the model data 34.

The time period for obtaining the model data 34 can be predetermined or programmed by a user for use in generating the model. The patient population and sources of data 18 can include data for a single institution or facility. Alternatively, it may include an inter-institutional set of data that is acquired from multiple data sources 18 and aggregated together for the patient population. For instance, the sources of data 18 can be distributed databases that store corresponding data for different parts of the patient population that has been selected for use in generating the model.

The data extractor 16 can include data inspection logic 32 to analyze the extracted data and to assign values to each data element. As an example, the data inspection logic 32 can evaluate the final coded data elements that are extracted from the one or more data sources 20 through 22, and assign a corresponding value based on the content for each data element. The data inspection logic 32 sets the value for one or more data elements in each of the respective fields in the model data 34 based on comparing the value of the extracted data element relative to a set of possible codes (e.g., ICD-9 and/or ICD-10 codes). In this way, the set of possible codes define the parameter space from which the predictor variables can be selected. The comparison can assign the value depending on whether a given one of the possible codes has a corresponding coded value in the extracted data for a respective patient. The model data 34 can be a predefined table or other data structure designed to accommodate dynamic input data elements extracted from the sources of data 18. Each data element in the model data 34 can correspond to a predictor variable that is utilized to generate the model.

By way of example, the data inspection logic 32 can be programmed to assign a value of 0 or 1 (e.g., a dummy code) to each record or code element for the data extracted from the respective data sources 20 and 22. For example, a value of 1 can be assigned to a coded data element that contains data in one or more of the data sources indicating that the data element defined as a member for a respective variable set of possible codes. A data element that contains no information (e.g., null data) can be assigned a value of 0 by the data inspection logic and stored as part of the model data 34, indicating that it is not a member for the respective variable in the set of possible codes. In this way, the model generator 36 can generate a model 38 for predicting a desired patient outcome based on whether or not (e.g., depending on the presence or absence of) a given code entry exists in the final coded data set that has been extracted from the selected data sources 20 and 22 for each patient in the final coded data set. As a still further example, some data elements can be assigned values based on a range in which the value of data element. For example, a plurality of different age ranges can be potential predictor variables and a given patient's age can be assigned a value (e.g., 0 or 1) depending on the age data element's membership in a corresponding age range.

As another example, some data elements can be assigned a value of 0 or 1 based on the content of such extracted data elements, such as demographic information in a patient record, responses from patient surveys in a quality record or other objective and/or subjective forms of data (e.g., text or string data) that may be stored in the data set in connection with a given data element. For instance, for a gender data element, the data inspection logic 32 can encode different sexes differently (e.g., male can be coded as a 0 and female can be encoded as a 1). The binary value that is assigned to content in a descriptive type of data element can vary according to user preferences so long as the coding values are consistently applied by the data inspection logic during generation of the model and for prediction. As yet another example, other types of data elements can be assigned values that are equivalent to the content in the extracted data (e.g., lab results, age and the like) or may vary as a mathematical function of the extracted data.

In order to facilitate the handling of the corresponding data that is being analyzed, the data inspection logic 32 can employ a plurality of field buckets that is a proper subset of the available types of extracted data and complete set of final codes in which data is classified and stored in the data sources 20 and 22. For example, at least some of the field buckets of the field data structure (e.g., the above Table) can each store values for multiple (e.g., a range of) code elements. Alternatively, the data inspection logic 32 can store the corresponding values for each data element in an individual field of the model data 34 for each respective data element and final code that comprises the extracted data. As one example, the foregoing table provides a list of categories (e.g., corresponding to field buckets) that can be utilized for holding predictor variable values that are stored as the model data 34. It is to be understood and appreciated that the list of fields in the Table demonstrates but a single example, and that in other examples the particular set of fields can vary according to application requirements.

Additionally, by organizing one or more of the coded data sets into ranges of code elements, such as corresponding to different categories or organizational criteria, the data inspection logic 32 can accommodate yet unknown dynamic variables that may arise within a given category of predictive factor. That is, the approach affords flexibility since the data inspection logic can easily be programmed to assign one or more new code elements to a given existing range or change the distribution of code elements by modifying which predictor variables are assigned to which field ranges. Additional ranges may also be added in response to a user input (e.g., entered via the user interface 28) such as to accommodate increases in data fields and/or new categories. Additionally, the data inspection logic 32 can be applied to all predictive category factors or to a subset of them. The subset of predictive category factors can be selected according to the criteria used to categorize the ranges of code elements or based on individual code elements deemed relevant to a model being generated.

As a further example, the data inspection logic 32 can assign data element values to a given field bucket of the data structure selected based on the type of data element. For instance, a data element from one of the data sources 18 (e.g., a given ICD-9 code from the EHR database 20) can include a code identifier and a code value. The data inspection logic 32 can evaluate the code identifier or a portion thereof and, based upon the respective digits, determine to which field bucket such data element maps such that the determined data element value can be inserted in the data structure accordingly.

As one example, a problem list ICD-9 code 2940 can be stored in field ICD-9_PBL_{—}2_{—}5 of the Table in response to the data inspection logic 32 determining the value of the first character of the code is a ‘2’ and the second character is greater than or equal to ‘5’. As another example, a problem list ICD-9 code 34501 can be stored in field ICD-9_PBL_{—}3 because the value of the first character is a 3 and the second character is less than 5. Thus, by categorizing and selectively assigning data element values to associated field buckets that cover a range of code values, the dynamic nature of the patient data in the data source 18 can be accommodated more easily in the system 10. As a result, as changes are made to the data 18, such as by adding new data elements or other parameters, such data elements can be dynamically allocated to different ranges of the field buckets, such as shown and described herein.

Due to the potential size of the data that stores the values of predictor variables determined by the data inspection logic 32, the model data 34 can be stored as multiple data files, which can be aggregated together as part of the model generation process. As one example, the extractor 16 can generate the model data 34 as including two or more files that represent the data elements and the corresponding values determined for each data element by the data inspection logic 32. The extractor 16 can also provide a separate file that represents column headings each of the field buckets (e.g., categories of data elements) into which the data inspection logic 32 has assigned the data. Since the data elements can comprise a set of disparate data sources 18, the data extractor 16 can concatenate all codes and other data fields together to create an aggregate column heading file that can be utilized by a model generator 36. As an alternative to storing the data as multiple files, the model data 34 can include a single file in the memory 14.

Appendices A and B provide examples of model data that can be utilized in the system 10 based on the data inspection logic allocating and assigning values to the corresponding field buckets. Appendix A depicts an example of a file that can be generated corresponding to the values of the data. Appendix B demonstrates an example of a heading file that can be utilized in conjunction with value data of Appendix A.

The model generator 36 can be programmed to generate a corresponding predictive model 38 based on processing the model data 34 provided by the data extractor 16. The model generator 36 can provide the model 38 as having a plurality of predictor variables (e.g., corresponding to selected data elements from the model data 34) that correspond to a selected set of the possible codes. Each of the predictor variables in the model 38 can include weights that have been calculated by the model generator 36 based on a concordance index of the predictor variable to the patient outcome that is being predicted. The weights can be fixed for a given predictor variable or a weight can be variable as a function one or more other variables.

As an example, the model generator 36 may employ a least absolute shrinkage and selection operator (LASSO) method, another minimization of the least square penalty or another regression algorithm to generate the model 38 that includes a subset of coefficients and predictor variables. For instance, the model generator 36 can employ principle component analysis and patient data that is stored as the model data 34 for the plurality of patients to rank predictor variables according to their relative efficacy in predicting the selected outcome. Based upon the ranking of the predictor variables, the model generator 36 can select a proper subset of possible predictor variables from the ranked list for use in generating the model 38.

As an example, as part of the LASSO method that can be performed by the model generator 36, different sets of coefficients and predictor variables can be determined for different values of LAMBDA. Lambda corresponds to a programmable penalty parameter that represents an amount of shrinkage done by the LASSO method, which controls the number of predictor variables and associated coefficients.

By way of further example, assuming that the model generator is being employed to generate the model 38 for predicting hospital length of stay (LOS) in days, the LASSO method can be implemented for finding optimal regression coefficients β. To meet the requirement of Gaussian distribution of the dependent variable, the input data can be transformed by natural logarithm function first before entering into the regression modeling. Hence, the predicted values directly from the penalized LASSO regression will be log scale, which can be transformed back by natural exponential function to normal scale (in days).

Continuing with the LOS example via the LASSO method, the regression function for response variable Y (i.e. log(LOS))∈R and a predictor vector X∈R^{P} can be represented as:

E(Y|X=x)=β₀+x^{T}β

The optimal coefficients β can be solved by the following equations for a given penalty level λ,

$${min}_{( {β}_{0} , β ) ∈ {R}^{p + 1}} [ \frac{1}{2 N} {\sum }_{i = 1}^{N} {( {y}_{i} - {β}_{0} - {x}^{TB} )}^{2} + λ ‖ β ‖ ]$$

where N is the total number of subjects in the data base, and

P is the total number of predictor variables.

∥β∥ is the absolute value of β.

For instance, a larger Lambda results in a greater number of predictor variables. For each value of Lambda, each set of corresponding coefficients and predictor variables can be evaluated to determine an optimal or best model such as that minimizes a mean cross-validation error. The model generator can in turn provide the predictor variable and associated coefficients for the best/optimal model based on the analysis. The resulting model 38 can be stored in the memory 14 for use by a predictor tool 40.

To determine a substantially optimal can be performed by k-cross-validation. For example, the solutions can be computed for a series of penalty values for λ, starting from the largest penalty value λₘₐₓ that forces all regression coefficients to be zero. The series of K values of λ can be constructed by setting λₘᵢₙ=ελₘₐₓ, which allows λ to decrease from λₘₐₓ to λₘᵢₙ equally on the log scale. The default values can be, for example, ε=0.001 and K=100. The optimal can thus be chosen through K fold cross-validation, where the dataset was partitioned into K parts. For a given λ, the total cross-validated mean predicted error can be represented as follows:

$$C {V}^{⋒} ( λ ) = {\sum }_{i = 1}^{k} \frac{1}{{N}_{i}} {\sum }_{j = 1}^{{N}_{i}} {( {y}_{ij} - {β}_{0 - i} ( λ ) - {xj}^{T} {β}_{- i} ( λ ) )}^{2}$$

where Nᵢ is the number of patients in left out i^{th} partition, and

β₀₋ᵢ(λ) and β₋ᵢ(λ) are the optimal regression coefficients that are optimized using the non-left out data for the given λ.

An optimal λ can be selected by minimizing the total cross-validated error C\hat{V}(λ), for example.

The following table represents an example of R code (e.g., in R programming language) that can be implemented for performing the LASSO Algorithm, such as described above.

# load the required R package ‘glmnet’
Require(glmenet)
# fit the lasso penalized least square model + 10 fold cross-
validation
# pname.select is the selected predictor variables
# loglos is the logarithm transformed length of stay in days
fit.las.cv <-
cv.glmnet(as.matrix(los.dat[,pname.select]),y=los.dat$loglos,
alpha = 1, family= “gaussian”)
# print the regression results
print(fit.las.cv)
# make a plot of mean prediction error against log(λ)
plot(fit.las.cv)
fit.las <- fit.las.cv$glmnet.fit
# extract the regression coefficients for the optimal λ
Coefficients.las <- coef(fit.las, s = fit.las.cv$lambda.min)
# extract the non-zero coefficients for the optimal λ
Active.Index.las <- which(abs(Coefficients.las) > tol )
Active.Coefficients.las <- Coefficients.las [Active.Index.las ]
length(Active.Coefficients.las)

As another example, a given user can access the prediction tool 40 via corresponding user interface 28 for controlling use of the model 38 for predicting a patient outcome. The prediction tool 40 thus can apply the model 38 for a given patient to a set of input patient data in response to a user input comprising instructions to compute a predicted outcome. The user input to use the model can be received via the user interface 28. The prediction tool 40 can store the predicted output in the memory 14. The prediction tool 40 can also employ an output generator 42 that can generate the corresponding output to a corresponding I/O device 30. For example, the prediction tool 40 can provide the corresponding output to the I/O device 30 in the form of text, a graphics or a combination of text and graphics to represent the predicted patient outcome. For instance, the output generator 42 can compare the predicted outcome to one more thresholds, such as can vary depending on the outcome for which the model has been generated.

As one example, some types of models, such as for diagnosing a medical condition, may have a single threshold (e.g., a risk threshold), which if the value of the predicted outcome computed by the prediction tool 40 exceeds the threshold, the output generator 42 can provide an output identifying the diagnosis for the given patient. The output generator 42 can employ multiple thresholds for models generated for other types of outcomes (e.g., readmission risk, patient satisfaction, length of stay and the like). For assessments based on these types of predicted outcomes, the output generator 42 can vary the output that is generated based on the value of the predicted outcome relative to the predicted outcome to the thresholds that have been set. Thus, as the risk of such an outcome increases (as determined relative to predetermined thresholds), the output can increase in scale commensurately with such risk. For instance, different graphical representations of such risk can be provided and/or can be color coded (e.g., yellow, orange, red) to indicate the level of severity. Other types of severity scales and risk indicators can be utilized, which can include providing a normalized scale of the value of the predicted outcome (e.g., as a percentage). By employing a variety of models various types of outcomes can be predicted for each patient in real-time during a patient's stay in the hospital and thereby help to mitigate the risk of negative outcomes and increase the likelihood of positive outcomes.

Additionally or alternatively, the output generator 42 can also programmed to generate and send a message to one or more persons based on the results determined by the prediction tool 40. For example, output generator 42 can cause one or more alphanumeric pages to be sent to one or more users via a messaging system (e.g., a hospital paging system). The recipient users can be predefined for each given patient, for example corresponding to one or more physicians, nurses or other health care providers. The output generator 42 can also be implemented to provide messages to respective users via one or more other messaging technologies, such as including a text messaging system, an automated phone messaging system, an email messaging system and/or the message can be provided within the context of an EHR system. The method of communication can be set according to user preferences, such as can be stored in memory as part of a user profile. By providing messages/alerts based on predicted outcomes in this manner health care providers can evaluate patient conditions and, as necessary, intervene and adjust patient care. In this way the system 10 can provide a tool to facilitate care and help improve outcomes.

As disclosed herein, the system 10 can be utilized to generate any number of one or more models for use in predicting (or forecasting) a variety of patient outcomes. Examples of predicted outcomes can include length of stay, medical diagnosis for a given patient condition, a prognosis for a given patient, patient satisfaction or other outcomes that can be computed based upon the model 38. Thus, there can be any number of one or more models 38 that can be applied to the input patient data for each respective patient and in turn predict corresponding outcomes for such patients. The multiple models 38 can be combined to drive messages/alerts to inform one or more selected healthcare providers based on aggregated predicted outcomes, for example.

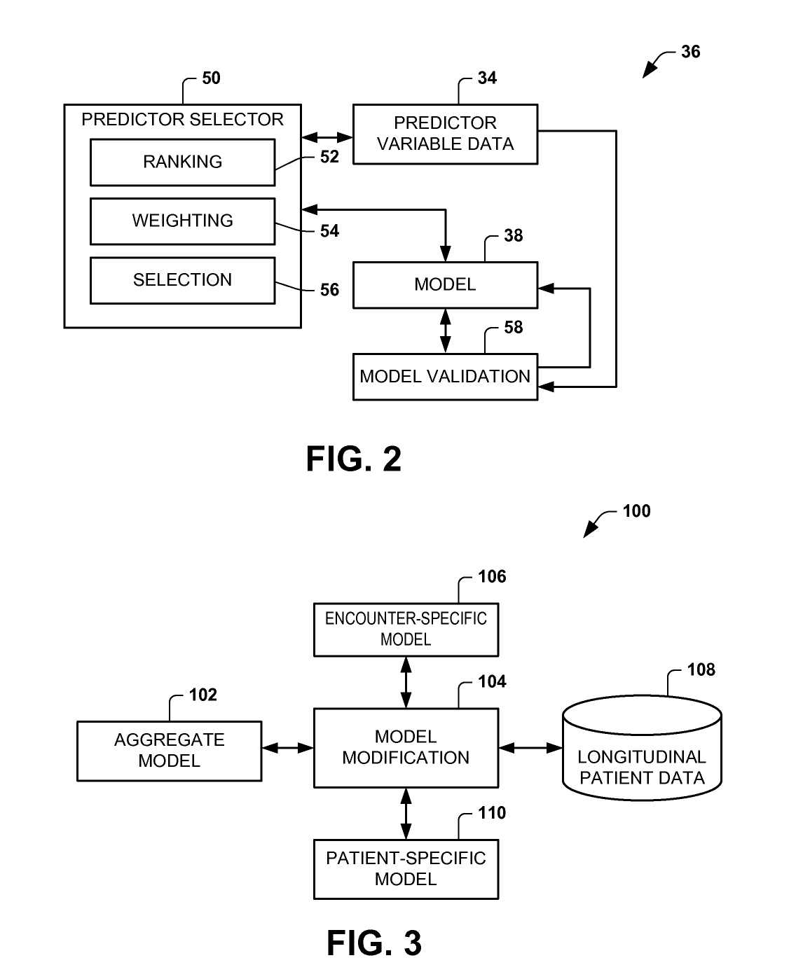

FIG. 2 depicts an example of a model generator 36 that can be utilized in generating a corresponding model 38 from model data, demonstrated as predictor variable data 34. The predictor variable data 34 contains data values for each of a plurality of data elements, such as can be obtained from one or more data sources for a plurality of patients. For instance, the data sources can include an EHR repository for one or multiple hospitals or research institutions as well as other sources from which predictor variable data can be acquired such as disclosed herein.

In the example of FIG. 2, the model generator 36 includes a predictor selector 50 that can be programmed for selecting a set of predictor variables for use in constructing the model 38. The predictor selector 50 can be implemented as machine readable instructions such as can be stored in one or more non-transitory storage media. The predictor selector 50 can include a ranking function 52 that can determine a relative importance of predictor variables according to the outcome for which the model 38 is being generated. The ranking function can further rank each of the predictor variables based on their determined relative importance. For example, the ranking function 52 can be implemented by performing principle component analysis.

The predictor selector 50 can also include a weighting method 54 that can determine weighting for the predictor variables by regularization of the predictor weights, such as according to the LASSO method. For example, the LASSO method can be further applied to the principle component analysis through selecting different values of LAMDBA for shrinking the sets of coefficients for the predictive variables. A selection function 56 can in turn select from the available sets of weighting coefficients and predictor variables as determined by the weighting and ranking functions 54 and 52, respectively. The selection function 56, for example, can be utilized to select and generate the model 38.

As an example, the selection function 56 can employ a concordance correlation coefficient to provide an indication of the inter-rater reliability for each of the different weighted sets of coefficients provided by the weighting function 54. For example, the weighting function 54 can produce a plurality of different sets of coefficients and predictor variables, corresponding to different values of LAMBDA according to the LASSO method. The selection function 52 can evaluate each of the respective sets of predictor variables and coefficients to ascertain the corresponding concordance to identify and select the best model. For instance, the selection function 56 can select the model by minimizing the mean cross-validation error. An example of respective coefficients for different LAMBDA values for predictor variables is demonstrated in Appendix C.

By way of example, as shown in Appendix C, the greater the LAMBDA, the lesser the total number of non-zero coefficients in a corresponding model. Thus, the selection function 52 can be programmed to evaluate coefficients and, based on such evaluation, select a proper subset of coefficients. The selected set of coefficients thus can define a corresponding model 38 that can be efficiently stored in memory and utilized in predicting a corresponding patient outcome for which the model 38 has been generated.

The model generator 36 further can include a model validation function (e.g., stored in memory as machine readable instructions). The model validation 58 can be implemented using a k-fold cross validation (e.g., where K is a positive integer, such as 10 or 100) in which k percent of the patient population can be set aside from the initial patient data (e.g., based on identifying the common unique identifier in both the final encoded data set and the patient encounter data set) from which the predictor variable data 34 is constructed. The model validation function 58 can utilize the set aside data as a subset from the input patient data. The model validation function 58 can apply the model 38 to such data and determine whether the model accurately predicts the actual outcome for the patients in the set aside based on a comparison between the actual outcome and the predicted outcome determined from the model. The set aside data thus can be retained as validation data for validating the model in which the remaining portion of the input data are used as the training data to generate the model 38. This can include a proper subset for a selected group of patients from both the training data and the encounter data, which group has been excluded from the process of generating the model. The cross validation process can be repeated for each of the K times for each of the folds, such that each of the K subsamples of data are used exactly once in the validation process. Other forms of validation methods can also be utilized to help ensure the efficacy of the resulting model 38.

FIG. 3 depicts an example of an aggregated model generation system 100 that can be utilized to create an aggregate model 102. The model generation system 100 can include a model modification method 104 that is programmed to modify an encounter-specific model 106, such as a corresponding model generated by the systems and methods of FIGS. 1 and 2 (e.g., model 38). The encounter-specific model 106 thus is generated for predicting a patient outcome based on analysis of model data generated from a plurality of patients' final coded data set that is stored in one or more sources of patient data. The encounter-specific model 106 thus can be utilized to predict an outcome generally for any patient. In some examples, longitudinal patient data 108 for a given patient may be relevant to determining coefficients and predictor variables relevant to predicting an outcome for the given patient. Thus, the model modification function 104 can modify the encounter-specific model 106 (e.g., generated by the model generator 36 of FIG. 2) and provide the aggregate model based upon the longitudinal patient data 108 for a given patient. That is, the model modification function 104 can adjust the model for a given patient depending on the given patient's circumstances.

As an example, the longitudinal patient data, for example, can include historical data for a given patient, such as may be stored in an EHR for the patient, based on patient questionnaires or other information that may relate to a patient's historical health or other circumstances. For instance, the model modification function 104 can modify weights from the encounter-specific model and/or coefficient values for any number of one or more predictor variables that perform the encounter-specific model 106. In some cases, the encounter-specific model 106 can be modified by longitudinal patient data for a plurality of different patients to provide the corresponding aggregate model 102.

Additionally or alternatively, the model modification function 104 further may be utilized to construct a patient-specific model 110. There can be any number of one or more patient-specific models 110 that can be constructed based upon longitudinal patient data 108 for each of a plurality of respective patients. The patient-specific model 110 can be constructed in a manner similar to the model 38 shown and described with respect to FIGS. 1 and 2, but based on longitudinal patient data for one or more patients. The model modification function further may be able to modify or combine the encounter-specific model 106 with the patient-specific model 110 for use in constructing the aggregate model 102. Once an aggregate model 102 has been constructed, similar model validation can be implemented, such as K-fold cross validation or the like.

A corresponding prediction tool (e.g., tool 40 of FIG. 1) can employ the aggregate model 102 (similar to the model 38 of FIG. 1) for use in predicting one or more patient outcomes for which each respective model has been generated. Any number of models can be generated for predicting any number of different patient outcomes and that each such model can be modified based upon the longitudinal patient data 108 as disclosed herein.

As mentioned above, various categories of patient satisfaction can also be utilized to construct a patient outcome model that can be utilized for predicting patient satisfaction, such as based on data obtained from patient surveys for a patient population. Data elements for predictor variables can correspond to responses to individual questions or groups of responses to survey questions can be aggregated to provide one or more predictor variables. For example, many hospitals or other institutions provide surveys to patients and customers the results of which can be stored in data, such as the other data 22 of FIG. 1.

Referring back to FIG. 1, the data inspection logic 32 can evaluate the conditions and generate corresponding model data along with the other patient data that may be stored in the record. Such combined sets of data can in turn be utilized to generate a corresponding model for predicting patient satisfaction in any number of one or more patient satisfaction categories as may be evaluated from a patient survey or other sources of data that document patient satisfaction. By predicting one or more aspect of such patient satisfaction, one or more messages can be provided by the output generator 42 to appropriate healthcare professionals in real time during a patient's stay. By informing such healthcare professionals early during a patient's stay based on predicted outcomes, predetermined preventative steps can be taken to increase the level of patient satisfaction (e.g., increased visits by nurses, physicians and/or social workers), and thereby improve the resulting patient experience.

As will be appreciated by those skilled in the art, portions of the invention may be embodied as a method, data processing system, or computer program product. Accordingly, these portions of the present invention may take the form of an entirely hardware embodiment, an entirely machine readable instruction embodiment, or an embodiment combining machine readable instructions and hardware. Furthermore, portions of the invention may be a computer program product on a non-transitory computer-usable storage medium having machine readable program code on the medium. Any suitable computer-readable medium may be utilized including, but not limited to, static and dynamic storage devices, hard disks, optical storage devices, and magnetic storage devices.

Certain embodiments of the invention can be implemented as methods, systems, and computer program products. It will be understood that blocks of the illustrations, and combinations of blocks in the illustrations, can be implemented by machine-readable instructions. These machine-readable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These machine-readable instructions may also be stored in computer-readable memory that can direct a computer or other programmable data processing apparatus to function in a particular manner, such that the instructions stored in the computer-readable memory result in an article of manufacture including instructions which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions disclosed herein.

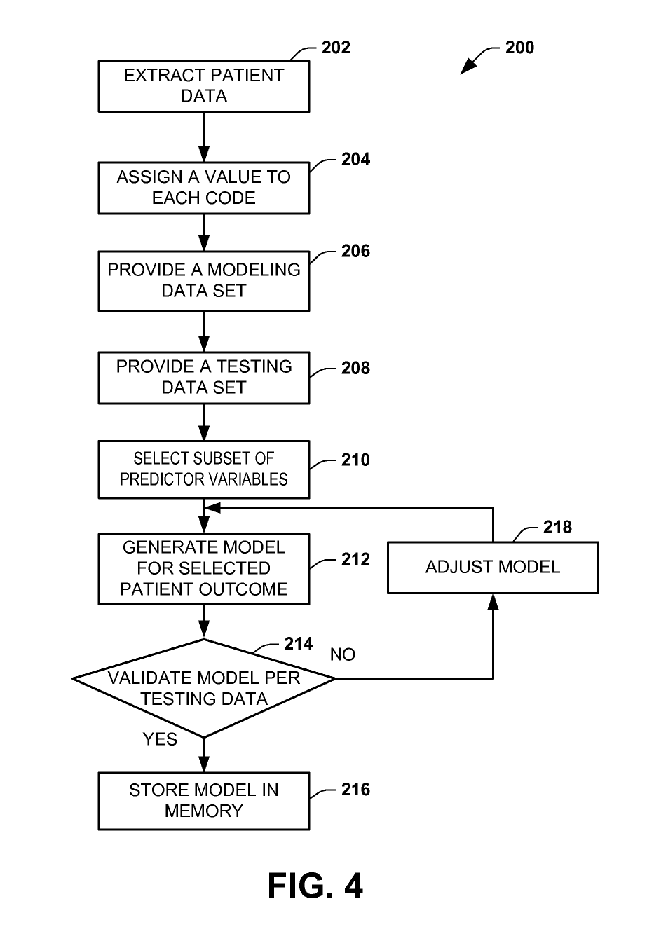

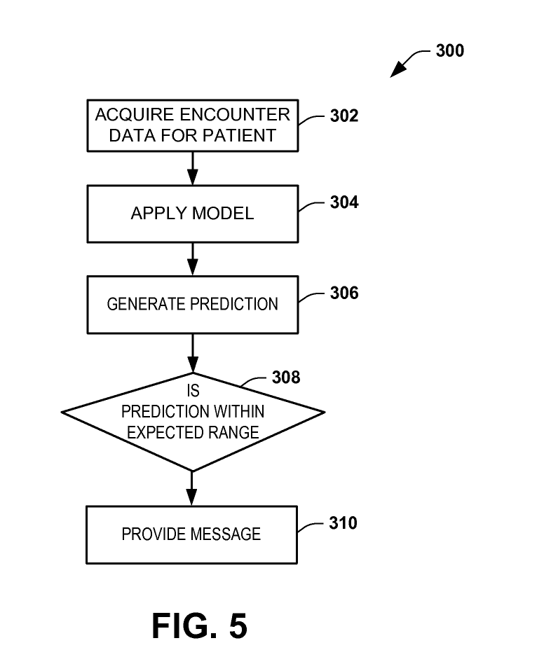

In view of the foregoing structural and functional features described above in FIGS. 1-3, example methods that can be implemented are disclosed with reference to FIGS. 4 and 5. While, for purposes of simplicity of explanation, the methods of FIGS. 4 and 5 are shown and described as executing serially, it is to be understood and appreciated that the present invention is not limited by the illustrated order, as some actions could in other examples occur in different orders and/or concurrently from that shown and described herein. The methods can be implemented as machine-readable instructions, or by actions performed by a processor implementing such instructions, for example.

FIG. 4 depicts an example of a method 200 that can be implemented to generate a model. At 202, the method includes extracting patient data from one or more database (e.g., via data extractor 16). As disclosed herein, the patient data can include final coded data for each of a plurality of patients. The patient data can also include other patient data for at least a subset of the patients.

At 204, a value is assigned to each code in a set of possible codes for each respective patient based on comparing data for each patient in the final coded data set relative to the set of possible codes. As disclosed herein, the final coded data set typically corresponds to a verified set of data after the patient encounter has been completed and reviewed by appropriate personnel. The final coded data thus can include ICD codes, procedure codes, demographic information and the like. The assigned values can be stored in memory to provide modeling data. At 204 value can also assigned to each code in a set of possible codes for each respective patient based on comparing data for each patient in the encounter data relative to the set of possible codes.

The values assigned at 204 can correspond to binary values that represent if a given code includes data or is empty (e.g., null data). Alternatively, the values can be numerical values, which can be the value stored in the data source or it can be normalized to a predetermined scale to facilitate generating the model. The set of possible codes can correspond to ICD codes (e.g., ICD-9 and/or ICD-10 codes) and procedure codes, for example. The set of codes can also include data representing patient gender and age. As disclosed herein, the extracted data can be aggregated and stored in memory as one or more files such as in an EHR repository or in a separate database.

At 206, a modeling data set can be provided and stored in memory. The modeling data set can be provided as corresponding to a selected subset of the patient data for which code values have been assigned at 204 for use in generating the model.

At 208, a testing data set can be provided. The testing data set can correspond to a different subset of the patient data (namely an encounter data set) for which code values have been assigned. The testing data set can be used for generating the model as well as validation purposes as disclosed herein. As disclosed herein, encounter data generally corresponds to preliminary data entered by one or more healthcare providers before or during a given patient encounter, but before the final coded data set is generated for each patient.

At 210, prior to generating the model, the predictor variables can be selected (e.g., by the predictor selector 50 of FIG. 2). For instance, the selection of predictor variables can include ranking, weighting and selection predictor variables for use in generating the model. The selecting of the subset of predictor variables can be performed according to the LASSO. Each of the predictor variables can have weights calculated based on a concordance index of the variable to the patient outcome.

At 212, the method 200 includes generating a model (e.g., via the model generator 36 of FIG. 1 or 2) for the selected patient based on the selected predictor variables and coefficients derived at 210. The predictor variables can be combined according to a principle component analysis, such as can be employed to generate a second set of predictor variables as a weighted combination of codes selected from the set of possible codes.

At 214, the model can be validated (e.g., by the model validation function 58 of FIG. 2) for predicting the selected event or outcome. The patient data used for validation can include a portion of testing data provided at 208. If the model validates properly, the method can proceed to 216 in which the generated model can be stored in memory (e.g., corresponding to model data 34 of FIG. 1). If the validation results in the model failing to validate within defined operating parameters, the model can be adjusted at 218 and then return to 212 for generating a new model. The new model will then be validated at 214 and it can be stored in memory at 216, if acceptable. More than one such model can be generated for predicting the selected event or outcome. For instance, different models can be generated for use in predicting the same event or condition based on different predictor variables and coefficients.

FIG. 5 depicts an example of method 300 for predicting an outcome using a model generated according to this disclosure (e.g., via the method 200 of FIG. 4). The method 300 can be utilized for predicting one or more selected outcomes as disclosed herein by applying one or more models to patient encounter data. At 302, the method includes acquiring encounter data for a patient. The encounter data can be obtained from an EHR or other patient record or other sources that store data for the patient. At 304, a model (e.g., the model 38 of FIG. 1 or 2) that has been generated can be applied (e.g., by the prediction tool 40 of FIG. 1) to the data acquired at 302. Based on application of the model, a prediction can be generated at 306 for the selected event or outcome.

At 308, the prediction value can be evaluated to determine if it is within an expected (e.g., normal) range. If it is normal the prediction can be stored in memory and a corresponding output can be generated (e.g., output to an I/O device 30 of FIG. 1) for viewing by the user that requested the prediction. If the prediction has a value that is not within the expected range, a message can be provided (e.g., an alert message via the output generator 42 of FIG. 1) to inform one or more predefined users of the predicted outcome or event depending on the model applied.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.

What is claimed is:

1. A computer implemented method, comprising:
extracting patient data from a database, the patient data comprising final coded data for each of a plurality of patients and encounter patient data for at least a subset of the plurality of patients;
assigning a value to each code in a set of possible codes for each respective patient based on comparing data for each patient in the final coded data relative to the set of possible codes to provide model data;
storing the model data in memory;
assigning a value to each code of the set of possible codes for each respective patient in the subset of patients based on comparing data for each patient in the encounter patient data relative to the set of possible codes to provide testing data;
storing the testing data in the memory;
generating a model for predicting a selected patient event or outcome, the model having a plurality of predictor variables, corresponding to a selected set of the possible codes, derived from the model data, each of the predictor variables having coefficients calculated from the testing data based on a concordance index of the respective predictor variable to the patient event or outcome; and
storing the model in the memory.

2. The method of claim 1, further comprising:
prior to generating the model, computing a ranked list of predictor variables from the set of possible codes that ranks each of the predictor variables according to their relative efficacy in predicting the event or outcome based on the model data; and
selecting a subset of the predictor variables from the ranked list, the model being generated based on the selected subset of predictor variables.

3. The method of claim 2, wherein the predictor variables are combined according to a principle component analysis.

4. The method of claim 3, wherein the principle component analysis comprises a method programmed to generate a second set of the predictor variables from the model data as a weighted combination of codes selected from the set of possible codes, the model being generated from the second set of the predictor variables.

5. The method of claim 2, wherein both the ranking and the selecting of the subset of predictor variables are performed according to a least absolute shrinkage and selection operator (LASSO) method applied to the model data.

6. The method of claim 5, wherein the predictor variables comprise ICD codes and procedure codes.

7. The method of claim 2, wherein the generation of the model further comprises computing coefficients for the selected subset of predictor variables based on a concordance correlation coefficient method applied to at least a portion of the testing data.

8. The method of claim 2, wherein the generating comprises generating a plurality of models for predicting a given patient event or condition, each of the plurality of models having a corresponding set of predictor variables with respective coefficients, the method further comprising:
receiving an input encounter data set for a certain patient;
selecting one of the plurality of models based on the input encounter data set; and
calculating a predicted patient event or condition for the certain patient based on the selected model and the input encounter data set.

9. The method of claim 8, wherein the input encounter data set comprises longitudinal patient data for the certain patient, the selected model is selected based on the longitudinal patient data.

10. The method of claim 1, wherein the patient encounter data comprises patient data entered by one or more health care professional during a given patient encounter, and
wherein the final coded data comprises patient data that is coded following patient discharge of each patient according to the set of possible codes.

11. The method of claim 10, wherein the set of possible codes comprises ICD codes and procedure codes.

12. The method of claim 11, wherein the set of possible codes further comprises data representing gender and age for each patient.

13. The method of claim 10, further comprising assigning a unique identifier for each patient that is common across each of the model data and the patient encounter data for each respective patient such that data for a given patient is associated with the same unique identifier in both the model data and the patient encounter data.

14. The method of claim 1, further comprising applying a set of patient encounter data for a given patient to the model to generate an output, the output comprising at least one of a predicted diagnosis for the given patient and a predicted prognosis for the given patient.

15. The method of claim 1, further comprising receiving an input encounter data set for a given patient, the input encounter data set comprising longitudinal patient data for the given patient; and
modifying the model for the given patient based on the longitudinal patient data to provide an encounter-specific model to facilitate prediction for the given patient; and
applying the input encounter data set to the encounter-specific model to provide a predicted output of a predicted patient event or condition for the given patient.

16. The method of claim 15, wherein the method further comprises:
generating a longitudinal model based on statistical analysis of the longitudinal patient data for each of the plurality of patients; and
aggregating the longitudinal model with the encounter-specific model to provide an aggregate predictive model.

17. The method of claim 1, wherein each assigning of the value further comprises dummy coding to indicate which data elements in the set of possible codes match corresponding data elements in the final coded data for each of the plurality of patients and in the patient encounter data for the subset of the patients.

18. The method of claim 1, wherein the patient data further comprises clinical data representing at least one clinical condition for at least some of the patients in the final coded data and at least some of patients in the patient encounter data, the clinical data being represented by natural values according to the clinical condition represented thereby, the method further modifying the model to include at least one clinical predictor variable and associated weight value based on analysis of the clinical data.

19. A system comprising:
memory to store computer readable instructions and data;
a processing unit to access the memory and execute the computer readable instructions, the computer readable instructions comprising:
an extractor programmed to extract patient data from at least one data source, the patient data comprising a final coded data set for each of a plurality of patients and a patient encounter data set for at least a subset of the plurality of patients;
data inspection logic programmed to assign a value to each code of a set of possible codes for each patient based on comparing data for each respective patient in the final coded data set relative to the set of possible codes to provide a modeling data set, the data inspection logic also being programmed to assign a value to each code of the set of possible codes based on comparing data for each patient in the patient encounter data set relative to the set of possible codes to provide a testing data set; and
a model generator programmed to generate a model having a plurality of predictor variables, corresponding to a selected set of the possible codes, each of the predictor variables having coefficients calculated based on a concordance index of each respective variable to a selected patient event or outcome for which the model is generated.

20. The system of claim 19, wherein the computer readable instructions further comprise:
a predictor selector, wherein prior to generating the model, the predictor selector being programmed to compute a ranked list of predictor variables from the set of possible codes that ranks each of the predictor variables according to their relative efficacy in predicting the event or outcome based on the modeling data, the predictor selector being programmed to select a subset of the predictor variables from the ranked list to define the predictor variables in the model.

21. The system of claim 20, wherein the predictor variables comprise a subset of ICD codes and procedure codes, wherein the predictor selector ranks and selects ICD codes and procedure codes to define the predictor variables for the model according to a least absolute shrinkage and selection operator (LASSO) method applied to the model data,
the model generator being programmed to compute the coefficients for the selected subset of predictor variables based on a concordance correlation coefficient method applied to at least a portion of the testing data set.

22. The system of claim 19, wherein the set of possible codes further comprises data representing gender and data representing age for each patient, the extractor assigning a value to the data representing age for each patient and a value to the data representing gender for each patient, such that the model accounts for gender and age in predicting the event or outcome for a given patient.

23. The system of claim 19, wherein the computer readable instructions further comprise:
a prediction tool configured to predict an event or outcome for a given patient based on applying the model to an input set of patient data acquired for the given patient; and
an output generator configured to generate an output corresponding to the predicted event or outcome.

24. The system of claim 19, wherein model is an encounter-specific model, the computer readable instructions further comprise:
a model modification function programmed to generate a longitudinal model based on statistical analysis of longitudinal patient data for each of the plurality of patients, the model modification function being programmed to aggregate the longitudinal model with the encounter-specific model to provide an aggregate model for predicting the event or outcome.

25. The system of claim 19, wherein the event or outcome comprises length of stay for a patient.
